(19) United States
(12) Patent Application Publication
(10) Pub. No.: US 2005/0102541 A1
(43) Pub. Date: May 12, 2005

(54) System controller for controlling an output state

(75) Inventor: Jean-Young Choi, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 10/982,351

(22) Filed: Nov. 5, 2004

(30) Foreign Application Priority Data
Nov. 6, 2003 (KR) 10-2003-0078415

(51) Int. Cl. G06F 1/26

(52) U.S. Cl. 713/300; 710/313

(57) ABSTRACT

The method and system disclosed is capable of controlling the output state of the controller. The system comprises an interface unit for providing electrical coupling to an electrical device, a controller electrically coupled to the interface unit for performing data communication with the electrical device, a processing unit for exchanging data between the controller with the interface unit, and a level converting circuit electrically for converting a power signal supplied through the interface unit to a control signal for a switch. The switch is electrically coupled to the level converting circuit for transmitting the power signal between the controller and the electrical device.

### CROSS-REFERENCE TO RELATED APPLICATIONS

Pursuant to 35 U.S.C. § 119(a), this application claims the benefit of earlier filing date and right of priority to Korean Application No. 10-2003-0078415, filed on Nov. 6, 2003, the contents of which are hereby incorporated by reference herein in their entirety.

### BACKGROUND OF THE INVENTION

1. Field of the Invention

The present invention relates to a system controller, and more particularly, to a system for controlling an output state of a USB controller.

2. Description of the Related Art

A system controller such as a Universal Serial Bus (USB) provides an electrical/mechanical interface for a system or a consumer product. Consumer products having USB controllers include, for example, MP3 players and digital cameras. In the case of personal computer, the PC transfers a power signal through a USB controller, whereby the power signal received by the USB controller is utilized to determine the data transmission speed.

Referring to FIG. 1, a product (hereinafter called ‘system’) 20 uses a USB controller 4 for exchanging data between a system 20 and a personal computer 30. The USB controller 4 connects to a personal computer 30 through a USB cable 15. The PC 30 supplies a USB power signal to a USB connector 2. The USB connector 2 functions as an interface unit for transmitting and/or receiving signals, for example data, to and from the PC 30.

The USB controller 4 receives the USB power signal from the PC 30 through a first line 21 connected to the USB connector 2. The USB controller 4 transmits the USB power signal through a second line 22. The USB controller 4 transmits the USB power signal through a pull-up resistance R 26 connected to a third line 23.

The third line (when powered-on) exchanges data between the PC 30 and the USB controller 4. The USB controller 4, in addition, receives through the third line 23 the USB power signal. The USB controller 4 uses the USB power signal for calculating the data transmission speed. A fourth line 24 supplies power from the PC 30 to the system 20. A central processing unit (CPU) 6 and a USB controller 4 performs exchanges of data using a fifth line 25.

However, when the system 20 is turned-off, the conventional USB controller 4 does not calculate the data transmission speed. Consequently, the exchange of data on the third line 23 is adversely affected. Additionally if conventional USB controller 4, while determining the speed of data transmission, is not recognized by the personal computer or if the system 20 initial state is unknown, the data may not be properly transmitted. Non-recognition of the system 20 by the PC 30 will cause the transmitted data on the third line 23 being lost or can cause the PC 30 to unexpectedly shut down.

Thus, there is a need for an improved system controller that solves problems from the prior art and provides additional advantages.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to a system and a method for controlling the flow of signals. More specifically, the method and system is capable of controlling the output state of a controller. The system controller comprises a processor for received/transmitted signals, an interface unit, a switch, and a controller. The interface unit provides a data path for communication signals. A switch provides a feedback path. The feedback path prevents the system receiving data from a connected electrical device when the system is powered-off.

In one embodiment, the system comprises a processing unit for controlling a USB controller, a USB connector electrically coupled to the processing unit having a data line for communication of signals with at least one electrical device, and the USB controller electrically coupled to the processing unit. The USB controller is powered-on before a signal is transferred to the data line.

In another embodiment, the system further comprises a switch electrically coupled between the USB controller and the USB connector for providing a feedback path to prevent the signal flowing to the data line when the system is powered-off. In yet another embodiment, the switch transmits the signal from the feedback path through the data line upon the system being powered-on.

The system further comprises a control circuit electrically coupled to the switch at one end and the USB controller at the other end, wherein the control circuit receives the control signal, if the system is powered-on, transmits the USB power to the data line.

The system further comprises a level converting circuit electrically coupled to the switch, wherein the level converting circuit controls the switch when the signal is applied to the system. In yet another embodiment, the level converting circuit converts the USB power signal applied from the USB connector into the control signal when the system and the USB controller are powered-on.

A method comprises generating by a processing unit a control signal for transmitting and receiving signals, and communicating with at least one electrical device thorough a USB connector electrically connected to the processing unit. The USB connector has at least one data line for electrically coupling to at least one electrical device, and powers-on a USB controller electrically coupled to the processing unit before a signal is transferred through at least one data line.

In another embodiment, the method further comprises providing a switch having a feedback path for the power signal from the at least one data line when the system is powered-off.

The method further comprises transmitting the power signal from the feedback path through the data line after the system is powered-on.

The method further comprises receiving a control signal by a control circuit if the system is powered-on for transferring the power signal.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

FIG. 1 is a block diagram illustrating a device using a conventional USB controller.

FIG. 2A is a block diagram illustrating a device employing a system for controlling an output state of a UBS controller in accordance with an embodiment of the present invention.

FIG. 2B is a flow diagram illustrating a device employing a method for controlling an output state of a USB controller in accordance with an embodiment of the present invention.

FIG. 3 is a block diagram of a mobile communication system incorporating the systems and the methods of the present invention.

FIG. 4 is a block diagram illustrating a UTRAN incorporating the systems and the methods of the present invention.

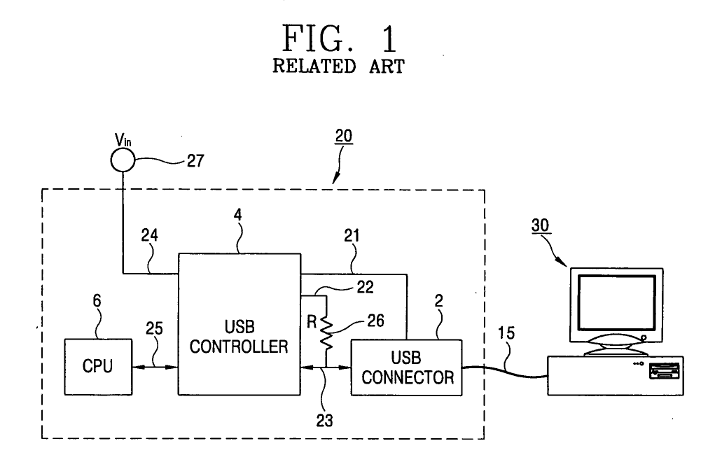

### DETAILED DESCRIPTION OF THE PREFERRED EMBODIMENTS

The present invention relates to controlling the flow of signals. The method and system is capable of controlling the output state of the controller. Although the invention is illustrated with respect to a USB controller, it is contemplated that the invention may be utilized anytime it is desired for transmitting or receiving signals from one location to another location. Well-known functions or constructions are not described in detail since they would obscure the invention in unnecessary detail.

The system controller of the present invention provides a solution to prevent conventional system controller affecting data when in the powered-off state. The system controller of the present invention provides a solution to a system controller not being recognized resulting in, for example, a personal computer displaying the system controller as an unknown device.

The system controller of the present invention provides a solution to prevent the controller having an unstable initial state, preventing the loss of data transmitted from a connected electrical device. The system controller also prevents a feedback signal affecting the data line of a system controller when power is not applied to the system.

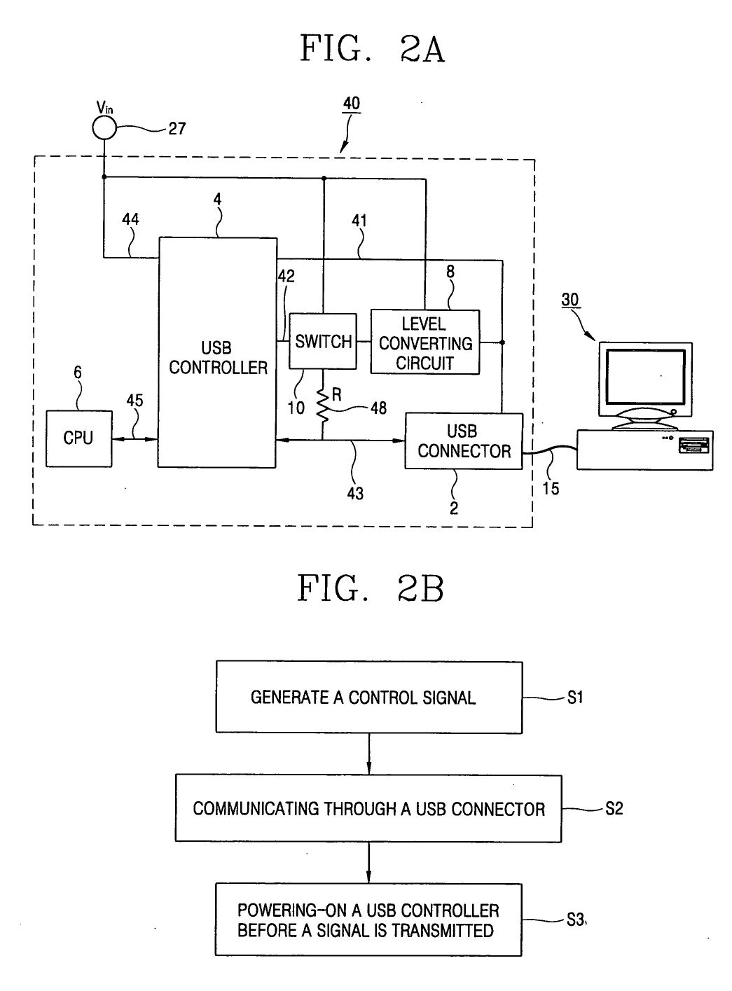

Referring to FIG. 2A, a universal serial bus (USB) connector 2 functions as an interface unit connected to a electrical device, such as a personal computer (PC) 30, through a USB cable 15 communicates signals and data between the personal computer (PC) 30 and the USB connector 2. A USB controller 4 is electrically connected to the USB connector 2 through a fifth electrical line 43. The PC 30 provides a USB power signal through USB connector 2 and a USB cable 15. The PC 30 also supplies the USB power signal to a level converting circuit 8 and the USB controller 4 through a first electrical line 41. The USB power signal is fed to a switch 10 for performing data communication with the PC 30. A central processing unit (CPU) 6 exchanges the data with the USB controller 4 upon the USB power signal being applied to the system 40.

Upon the system 40 being powered-up, a level converting circuit 8 receives the USB power signal from the USB connector 2. The level converting circuit 8 adjusts the level of the USB power signal and converts it to a control signal 42 for turning-on or turning-off the switch 10. The switch 10 provides a feedback path. The feedback path prevents (shields) the USB power signal being applied before application of the USB power signal to the system 40.

In one embodiment, a third electrical line 43 receives the USB power signal along the feedback path. The third electrical line 43 exchanges data between the USB controller 4 and the PC 30. The USB controller 4 feedbacks the USB power (applied from the USB connector 2) through a first electrical line 41 and a second electrical line 42, wherein the USB power is applied to the switch 10. When the switch 10 is in a turned-off state, the USB power signal is prevented (shielded) from being fed from the second electrical line 42. In this state, the USB power signal on the second electrical line 42 does not interfere with data exchanges on the third electrical line 43.

In yet another embodiment, when the USB power signal is applied to the system 40 through the fourth electrical line 44 to the USB controller 4, the level converter circuit 8 converts the USB power signal input at electrical line 41 into a control signal 42. The control signal 42 is connected to the switch 10. The switch 10 is turned-on by the control signal 42. In this turned-on state, the USB power signal received through the second electrical line 42 is transmitted to the third electrical line 43 through pull-up resistance R 48. At this time, the data transmitting speed is determined. The CPU 6 and the USB controller 4 exchange the data through the fifth electrical line 45.

Referring to FIG. 2B, a method for controlling signal flow of a USB connector is disclosed. The method comprises generating by a processing unit a control signal for transmitting and receiving signals (S1), and communicating with at least one electrical device thorough a USB connector electrically connected to the processing unit (S2). The processing unit has at least one data line for electrically coupling to at least one electrical device. The method further comprises powering-on a USB controller electrically coupled to the processing unit before a signal is transferred through at least one data line (S3).

The method may further comprise providing a switch having a feedback path for the power signal from the at least one data line when the system is powered-off. In yet another embodiment, the power signal is transmitted from the feedback path through the data line after the system is powered-on. In an alternative embodiment, a control signal is received by a control circuit if the system is powered-on for transferring the power signal.

In yet another embodiment, the method may comprise a level converting circuit electrically coupled to the switch. The level converting circuit controls when the power signal is applied to the system and/or comprise converting the USB power signal applied to the USB connector into the control signal when the USB controller is powered-on.

The following are examples of a mobile communication device and a mobile communication network using the systems and the method of the present invention.

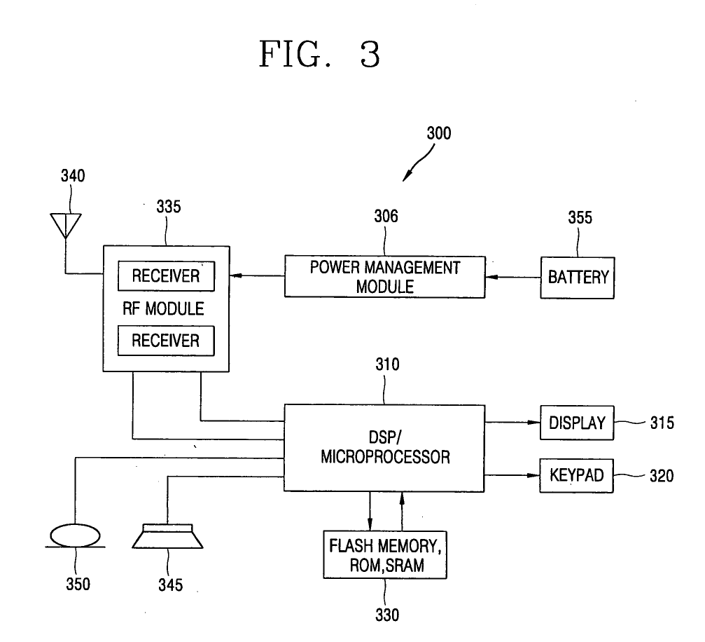

Referring to FIG. 3, the mobile communication device 300 comprises a processing unit 310 such as a microprocessor or digital signal processor, an RF module 335, a power management module 306, an antenna 340, a battery 355, a display 315, a keypad 320, a storage unit 330 such as flash memory, ROM or SRAM, a speaker 345 and a microphone 350.

A user enters instructional information, for example, by pushing the buttons of a keypad 320 or by voice activation using the microphone 350. The processing unit 310 receives and processes the instructional information to perform the appropriate function. Operational data may be retrieved from the storage unit 330 to perform the function. Furthermore, the processing unit 310 may display the instructional and operational information on the display 315 for the user's reference and convenience.

The processing unit 310 issues instructional information to the RF module 335, to initiate communication, for example, transmit radio signals comprising voice communication data. The RF module 335 comprises a receiver and a transmitter to receive and transmit radio signals. The antenna 340 facilitates the transmission and reception of radio signals. Upon receive radio signals, the RF module 335 may forward and convert the signals to baseband frequency for processing by the processing unit 310. The processed signals would be transformed into audible or readable information outputted via the speaker 345.

The processing unit 310 performs the methods and provides the systems as illustrated in FIG. 2. As an example, the processing unit 310 comprises a controller controlling a USB controller, a USB connector electrically coupled to the processing unit having a data line for communication of signals with at least one electrical device, and the USB controller electrically coupled to the processing unit. The USB connector is powered-on before a signal is transferred through the data line. Other features, as described above in FIG. 2, may be incorporated as well into the processing unit 310.

The processing unit 310 stores the messages received from and messages transmitted to other users in the storage unit 330, receive a conditional request for message input by the user, process the conditional request to read data corresponding to the conditional request from the storage unit. The processing unit 310 outputs the message data to the display unit 315. The storage unit 330 is adapted to store message data of the messages both received and transmitted.

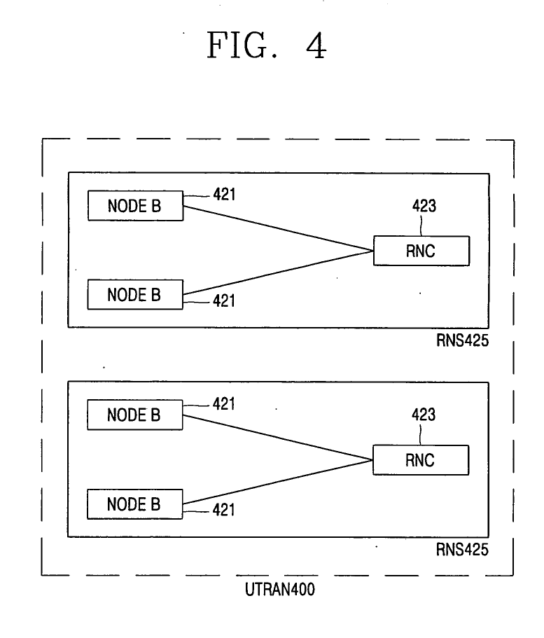

Referring to FIG. 4, the UTRAN 400 includes one or more radio network sub-systems (RNS) 425. Each RNS 425 includes a radio network controller (RNC) 423 and a plurality of Node-Bs (base stations) 421 managed by the RNC. The RNC 423 handles the assignment and management of radio resources and operates as an access point with respect to the core network. Furthermore, the RNC 423 is adapted to perform the methods of the present invention.

The Node-Bs 421 receive information sent by the physical layer of the terminal through an uplink, and transmit data to the terminal through a downlink. The Node-Bs 421 operate as access points, or as a transmitter and receiver, of the UTRAN 400 for the terminal. It will be apparent to one skilled in the art that the mobile communication device 300 may be readily implemented using, for example, the processing unit 310 (of FIG. 3) or other data or digital processing device, either alone or in combination with external support logic.

As an example, the controller is a system for controlling flow of a communication signal. The system comprises an interface unit for providing electrical coupling to an electrical device, a controller electrically coupled to the interface unit for performing data communication with the electrical device, a processing unit for exchanging data between the controller with the interface unit, and a level converting circuit for converting a power signal through the interface unit to a control signal for a switch. The switch electrically coupled to the level converting circuit for transmitting the power signal between the controller and the electrical device. In this example, the level converting circuit converts an power signal supplied through the interface unit to a control signal for controlling the flow of a data signal between the controller and the electrical device. The controller also performs the methods and the systems as illustrated in FIG. 2.

It will be apparent to one skilled in the art that the preferred embodiments of the present invention can be readily implemented using, for example, the processing unit 310 (of FIG. 3) or other data or digital processing device, either alone or in combination with external support logic.

Although the present invention is described in the context of a consumer product such as a MP3 player, the present invention may also be used in any wired or wireless communication systems using mobile devices, such as PDAs and laptop computers equipped with wired and wireless wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

The preferred embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.).

Code in the computer readable medium is accessed and executed by a processor. The code in which preferred embodiments are implemented may further be accessible through a transmission media or from a file server over a network. In such cases, the article of manufacture in which the code is implemented may comprise; a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The logic implementation shown in the figures described specific operations as occurring in a particular order. In alternative implementations, certain of the logic operations may be performed in a different order, modified or removed and still implement preferred embodiments of the present invention. Moreover, steps may be added to the above described logic and still conform to implementations of the invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Accordingly, the invention is not limited to the precise embodiments described in detail hereinabove.

With respect to the claims, it is applicant's intention that the claims not be interpreted in accordance with the sixth paragraph of 35 U.S.C. section 112 unless the term “means” is used followed by a functional statement.

In the claims, means-plus-function clauses are intended to cover the structure described herein as performing the recited function and not only structural equivalents but also equivalent structures. Further, with respect to the claims, it should be understood that any of the claims described below may be combined for the purposes of the invention.

1. A system for controlling the output state of a USB connector, the system comprising:
a processing unit for controlling a USB controller;
a USB connector electrically coupled to the processing unit having a data line for communication of signals with at least one electrical device; and
the USB controller electrically coupled to the processing unit, wherein the USB connector is powered-on before a USB power signal is transferred through the data line.

2. The system of claim 1, further comprising a switch electrically coupled between the USB controller and the USB connector for providing a feedback path to prevent the signal flowing to the data line when the system is powered-off.

3. The system of claim 2, wherein the switch transmits the signal from the feedback path through the data line upon the system being powered-on.

4. The system of claim 2, further comprising a control circuit electrically coupled to the switch at one end and the USB controller at the other end, wherein the control circuit receives the control signal, and if the system is powered-on, transmits the USB power signal to the data line.

5. The system of claim 2, further comprising a level converting circuit electrically coupled to the switch, wherein the level converting circuit controls the switch when the USB power signal is applied to the data line.

6. The system of claim 5, wherein the level converting circuit converts the USB power signal from the USB connector into the control signal when the system is powered-on.

7. The system of claim 1, wherein the data line exchanges data between the USB controller and at least one electrical device, wherein the USB power signal is used by the USB controller, when the USB controller is powered-on, for determination of a rate of data transmission of the data line.

8. A system for controlling a communication signal between an interface unit and an electrical device, the system comprising:
an interface unit for providing electrical coupling to an electrical device;
a controller electrically coupled to the interface unit for performing data communication with the electrical device;
a processing unit for exchanging data between the controller with the interface unit; and
a level converting circuit for converting a power signal supplied through the interface unit to a control signal for controlling a switch, and
the switch electrically coupled to the level converting circuit, when the power signal is transmitted through a data line between the controller and the interface unit.

9. The system of claim 8, wherein the switch provides a feedback path, upon the system powered-off, preventing the power signal being transmitted to the interface unit, and upon the system powered-on, transmitting the power signal to the interface unit.

10. The system of claim 8, wherein the interface unit is a USB connector.

11. The system of claim 8, wherein the controller is a USB controller.

12. The system of claim 8, wherein the interface unit is connected to the electrical device through a cable and provides the power signal from the electrical device.

13. The system of claim 8, wherein the controller feedbacks the power signal applied from the interface unit from a first line to the switch through a second line.

14. The system of claim 11, wherein the switch is powered-off to prevent the power signal feeding back to the data line located between the USB controller and the electronic device, wherein the data line exchanges the data between the USB controller and the electronic device.

15. The system of claim 8, wherein the level converting circuit converts the USB power applied through a first line into a control signal and outputs the control signal to the switch.

16. An method for controlling signal flow of a USB connector, the method comprising:
generating by a processing unit a control signal for transmitting and receiving signals;
communicating with at least one electrical device thorough a USB connector electrically connected to the processing unit having at least one data line for electrically coupling to at least one electrical device; and
powering-on a USB controller electrically coupled to the processing unit before a signal is transferred through at least one data line.

17. The method of claim 16, further comprising providing a switch having a feedback path for the power signal from the at least one data line when the system is powered-off.

18. The method of claim 16, further comprising transmitting the power signal from the feedback path through the data line after the system is powered-on.

19. The method of claim 16, further comprising receiving a control signal by a control circuit if the system is powered-on for transferring the power signal.

20. The method of claim 16, further comprising a level converting circuit electrically coupled to the switch, wherein the level converting circuit controls when the power signal is applied to the system.

21. The method of claim 16, further comprising converting the USB power signal applied to the USB connector into the control signal when the USB controller is powered-on.

22. The system of claim 16, wherein the data line exchanges data between the USB controller and at least one electrical device being a personal computer.

23. A mobile communication system for managing messages received from and transmitted to another user by a user of the mobile communication system, the mobile communication system comprising:
an RF module comprising a transmitter to send the transmitted messages from a user and a receiver for receiving messages from another user;
a processing unit for controlling a USB controller;
a USB connector electrically coupled to the processing unit having a data line for communication of signals with at least one electrical device; and
a USB controller electrically coupled to the processing unit, wherein the USB connector is powered-on before a signal is transferred to the data line.

24. The system of claim 23, further comprising a switch electrically coupled between the USB controller and the USB connector for providing a feedback path to prevent the signal flowing to the data line when the system is powered-off.

25. The system of claim 23, wherein the switch transmits the signal from the feedback path through the data line upon the system being powered-on.

26. The system of claim 23, further comprising a control circuit electrically coupling to the switch at one end and the USB controller at the other end, wherein the control circuit receives the control signal, if the system is powered-on, for transmitting the signal.

27. A network for radio communication in a mobile communication system, the network comprising:
at least one transmitter for transmitting a communication signal to at least one receiver;
an interface unit for providing electrical coupling to an electrical device;
a controller electrically coupled to the interface unit for performing data communication with the electrical device;
a processing unit for exchanging data between the controller with the interface unit;
a level converting circuit for converting a power signal supplied through the interface unit to a control signal for a switch,
wherein the switch is electrically coupled to the level converting circuit for transmitting the power signal between the controller and the electrical device.

28. The system of claim 27, wherein the switch provides a feedback path preventing the data signal flowing through the interface unit when the power signal is powered-off and transmits a data signal to the interface unit when the power signal is powered-on.

29. The system of claim 27, wherein the interface unit is a USB connector.

30. The system of claim 27, wherein the controller is a USB controller.

31. The system of claim 27, wherein the interface unit is connected to the electrical device through a cable and provides the power signal from the electrical device.

32. The system of claim 27, wherein the controller feedbacks the power signal applied from the interface unit from a first line to the switch through a second line.
